(19) United States
(12) Patent Application Publication
(10) Pub. No.: US 2022/0237806 A1
(43) Pub. Date: Jul. 28, 2022

(54) IMAGE PROCESSING AND NEURAL NETWORK TRAINING METHOD, ELECTRONIC EQUIPMENT, AND STORAGE MEDIUM

(71) Applicant: BEIJING SENSETIME TECHNOLOGY DEVELOPMENT CO., LTD., Beijing (CN)

(72) Inventors: Zhuowei LI, Beijing (CN); Qing XIA, Beijing (CN)

(21) Appl. No.: 17/723,580

(22) Filed: Apr. 19, 2022

Related U.S. Application Data
(63) Continuation of application No. PCT/CN2020/103635, filed on Jul. 22, 2020.

(30) Foreign Application Priority Data
Oct. 31, 2019 (CN) 201911050567.9

(51) Int. Cl. G06T 7/246; G06N 3/08

(52) U.S. Cl. CPC G06T 7/246; G06N 3/082; G06T 2207/30101; G06T 2207/20084; G06T 2207/20081

(57) ABSTRACT

An image to be processed is acquired. At least one candidate pixel on the target to be tracked is determined based on a current pixel on a target to be tracked in the image to be processed. An evaluated value of the at least one candidate pixel is acquired based on the current pixel, the at least one candidate pixel, and a preset true value of the target to be tracked. A next pixel of the current pixel is acquired by performing tracking on the current pixel according to the evaluated value of the at least one candidate pixel.

### CROSS-REFERENCE TO RELATED APPLICATION

This is a continuation application of International Patent Application No. PCT/CN2020/103635, filed on Jul. 22, 2020, which claims benefit of priority to Chinese Application No. 201911050567.9, filed on Oct. 31, 2019. The entire contents of International Patent Application No. PCT/CN2020/103635 and Chinese Application No. 201911050567.9 are incorporated herein by reference in their entireties.

### TECHNICAL FIELD

The present disclosure relates to the field of image analysis, and relates, but is not limited, to an image processing and neural network training method, an electronic equipment, and a storage medium.

### BACKGROUND

In related art, for a target to be tracked, such as a vascular tree, pixel extraction facilitates further research on the target to be tracked. For example, for complicated blood vessels such as cardiac coronary arteries, cranial blood vessels, etc., the way to extract a pixel of a blood vessel image is gradually becoming a research hotspot. However, in related art, there is a pressing need for a way to track and extract a pixel of a target to be tracked.

### SUMMARY

Embodiments of the present disclosure are to provide an image processing and neural network training method, an electronic equipment, and a storage medium.

Embodiments of the present disclosure provide an image processing method. The method includes:

acquiring an image to be processed;

determining, based on a current pixel on a target to be tracked in the image to be processed, at least one candidate pixel on the target to be tracked;

acquiring an evaluated value of the at least one candidate pixel based on the current pixel, the at least one candidate pixel, and a preset true value of the target to be tracked; and

acquiring a next pixel of the current pixel by performing tracking on the current pixel according to the evaluated value of the at least one candidate pixel.

It is seen that in the embodiment of the present disclosure, for a target to be tracked, a next pixel is determined from a current pixel according to an evaluated value of a candidate pixel. That is, pixel tracking and extraction directed at the target to be tracked are implemented accurately.

In some embodiments of the present disclosure, the foregoing image processing method further includes: before determining, based on the current pixel on the target to be tracked in the image to be processed, the at least one candidate pixel on the target to be tracked, determining whether the current pixel is located at an intersection point of multiple branches on the target to be tracked; in response to the current pixel being located at the intersection point, selecting a branch of the multiple branches, and selecting the candidate pixel from pixels on the branch selected.

It is seen that by determining whether the current pixel is located at an intersection point of respective branches on the target to be tracked, pixel tracking is implemented for respective branches, that is, when the target to be tracked has branches, embodiments of the present disclosure implement pixel tracking directed at the branches of the target to be tracked.

In some embodiments of the present disclosure, selecting the branch of the multiple branches includes:

acquiring an evaluated value of each branch of the multiple branches based on the current pixel, pixels of the multiple branches, and the preset true value of the target to be tracked; and

selecting the branch from the multiple branches according to the evaluated value of the each branch of the multiple branches.

It is seen that, in embodiments of the present disclosure, for an intersection point of the target to be tracked, one branch is selected from the multiple branches according to evaluated values of the multiple branches, that is, a branch of the intersection point is selected accurately and reasonably.

In some embodiments of the present disclosure, selecting the branch from the multiple branches according to the evaluated value of the each branch of the multiple branches includes:

selecting the branch with a highest evaluated value in the multiple branches.

It is seen that the branch selected is the branch with the highest evaluated value, and the evaluated value of the branch is acquired based on the true value of the target to be tracked. Therefore, the branch selected is more accurate.

In some embodiments of the present disclosure, the foregoing image processing method further includes:

in response to performing tracking on the pixels of the branch selected, and determining that a preset branch tracking stop condition is met, for an intersection point with uncompleted pixel tracking that has a branch where pixel tracking is not performed, reselecting a branch where pixel tracking is to be performed, and performing pixel tracking on the branch where pixel tracking is to be performed; and

in response to nonexistence of the intersection point with uncompleted pixel tracking, determining that pixel tracking has been completed for each branch of each intersection point.

It is seen that by performing pixel tracking on each branch of each intersection point, the task of pixel tracking over the entire target to be tracked is implemented.

In some embodiments of the present disclosure, reselecting the branch where pixel tracking is to be performed includes:

based on the intersection point with uncompleted pixel tracking, pixels of each branch of the intersection point with uncompleted pixel tracking where pixel tracking is not performed, and the preset true value of the target to be tracked, acquiring an evaluated value of the each branch where pixel tracking is not performed; and

selecting, according to the evaluated value of the each branch where pixel tracking is not performed, the branch where pixel tracking is to be performed from the each branch where pixel tracking is not performed.

It is seen that, in embodiments of the present disclosure, for an intersection point of the target to be tracked where pixel tracking is not performed, a branch is selected from the each branch where pixel tracking is not performed according to the evaluated value of the each branch where pixel tracking is not performed, that is, a branch of the intersection point is selected accurately and reasonably.

In some embodiments of the present disclosure, selecting, according to the evaluated value of the each branch where pixel tracking is not performed, the branch where pixel tracking is to be performed from the each branch where pixel tracking is not performed includes:

selecting the branch with a highest evaluated value in the each branch where pixel tracking is not performed.

It is seen that the branch selected is the branch with the highest evaluated value among the each branch where pixel tracking is not performed, and the evaluated value of the branch is acquired based on the true value of the target to be tracked. Therefore, the branch selected is more accurate.

In some embodiments of the present disclosure, the preset branch tracking stop condition includes at least one of the following:

a tracked next pixel being at a predetermined end of the target to be tracked;

a spatial entropy of the tracked next pixel being greater than a preset spatial entropy; or

N track route angles acquired consecutively all being greater than a set angle threshold, each track route angle acquired indicating an angle between two track routes acquired consecutively, each track route acquired indicating a line connecting two pixels tracked consecutively, the N being an integer greater than or equal to 2.

The end of the target to be tracked is pre-marked. When the tracked next pixel is at the predetermined end of the target to be tracked, it means that pixel tracking no longer has to be performed on the corresponding branch, in which case pixel tracking over the corresponding branch is stopped, improving accuracy in pixel tracking. The spatial entropy of a pixel indicates the instability of the pixel. The higher the spatial entropy of a pixel is, the higher the instability of the pixel, and it is not appropriate to continue pixel tracking on the current branch. At this time, jumping to the intersection point to continue pixel tracking improves accuracy in pixel tracking; when N track route angles acquired consecutively all are greater than a set angle threshold, it means the tracking routes acquired most recently have large oscillation amplitudes, and therefore, the accuracy of the tracked pixels is low. At this time, by stopping pixel tracking over the corresponding branch, accuracy in pixel tracking is improved.

In some embodiments of the present disclosure, acquiring the next pixel of the current pixel by performing tracking on the current pixel according to the evaluated value of the at least one candidate pixel includes:

selecting a pixel with a highest evaluated value from the at least one candidate pixel, and determining the pixel with the highest evaluated value as the next pixel of the current pixel.

It is seen that the next pixel is the pixel with the highest evaluated value among the candidate pixels, and the evaluated value of a pixel is acquired based on the true value of the target to be tracked. Therefore, the next pixel acquired is more accurate.

In some embodiments of the present disclosure, the target to be tracked is a vascular tree.

It is seen that in the embodiment of the present disclosure, for a vascular tree, a next pixel is determined from a current pixel according to an evaluated value of a candidate pixel. That is, pixel tracking and extraction directed at the vascular tree is implemented accurately.

Embodiments of the present disclosure also provide a neural network training method, including:

acquiring a sample image;

inputting the sample image to an initial neural network, and performing following steps using the initial neural network: determining, based on a current pixel on a target to be tracked in the sample image, at least one candidate pixel on the target to be tracked; acquiring an evaluated value of the at least one candidate pixel based on the current pixel, the at least one candidate pixel, and a preset true value of the target to be tracked; acquiring a next pixel of the current pixel by performing tracking on the current pixel according to the evaluated value of the at least one candidate pixel; and

adjusting a network parameter value of the initial neural network according to each tracked pixel and the preset true value of the target to be tracked;

repeating the above steps, until each pixel acquired by the initial neural network with the adjusted network parameter value meets a preset precision requirement, acquiring a trained neural network.

It is seen that in the embodiment of the present disclosure, when training a neural network, for a target to be tracked, a next pixel is determined from a current pixel according to an evaluated value of a candidate pixel. That is, pixel tracking and extraction directed at the target to be tracked are implemented accurately, so that the trained neural network accurately implements pixel tracking and extraction over the target to be tracked.

Embodiments of the present disclosure also provide an image processing device. The device includes: a first acquiring module and a first processing module.

The first acquiring module is configured to acquire an image to be processed.

The first processing module is configured to: determine, based on a current pixel on a target to be tracked in the image to be processed, at least one candidate pixel on the target to be tracked; acquire an evaluated value of the at least one candidate pixel based on the current pixel, the at least one candidate pixel, and a preset true value of the target to be tracked; and acquire a next pixel of the current pixel by performing tracking on the current pixel according to the evaluated value of the at least one candidate pixel.

It is seen that in the embodiment of the present disclosure, for a target to be tracked, a next pixel is determined from a current pixel according to an evaluated value of a candidate pixel. That is, pixel tracking and extraction directed at the target to be tracked are implemented accurately.

In some embodiments of the present disclosure, the first processing module is further configured to: before determining, based on the current pixel on the target to be tracked in the image to be processed, the at least one candidate pixel on the target to be tracked, determine whether the current pixel is located at an intersection point of multiple branches on the target to be tracked; in response to the current pixel being located at the intersection point, select a branch of the multiple branches, and select the candidate pixel from pixels on the branch selected.

It is seen that by determining whether the current pixel is located at an intersection point of respective branches on the target to be tracked, pixel tracking is implemented for respective branches, that is, when the target to be tracked has branches, embodiments of the present disclosure implement pixel tracking directed at the branches of the target to be tracked.

In some embodiments of the present disclosure, the first processing module is configured to: acquire an evaluated value of each branch of the multiple branches based on the current pixel, pixels of the multiple branches, and the preset true value of the target to be tracked; and select the branch from the multiple branches according to the evaluated value of the each branch of the multiple branches.

It is seen that, in embodiments of the present disclosure, for an intersection point of the target to be tracked, one branch is selected from the multiple branches according to evaluated values of the multiple branches, that is, a branch of the intersection point is selected accurately and reasonably.

In some embodiments of the present disclosure, the first processing module is configured to select the branch with a highest evaluated value in the multiple branches.

It is seen that the branch selected is the branch with the highest evaluated value, and the evaluated value of the branch is acquired based on the true value of the target to be tracked. Therefore, the branch selected is more accurate.

In some embodiments of the present disclosure, the first processing module is further configured to:

in response to performing tracking on the pixels of the branch selected, and determining that a preset branch tracking stop condition is met, for an intersection point with uncompleted pixel tracking that has a branch where pixel tracking is not performed, reselect a branch where pixel tracking is to be performed, and perform pixel tracking on the branch where pixel tracking is to be performed; and

in response to nonexistence of the intersection point with uncompleted pixel tracking, determine that pixel tracking has been completed for each branch of each intersection point.

It is seen that by performing pixel tracking on each branch of each intersection point, the task of pixel tracking over the entire target to be tracked is implemented.

In some embodiments of the present disclosure, the first processing module is configured to: based on the intersection point with uncompleted pixel tracking, pixels of each branch of the intersection point with uncompleted pixel tracking where pixel tracking is not performed, and the preset true value of the target to be tracked, acquire an evaluated value of the each branch where pixel tracking is not performed; and select, according to the evaluated value of the each branch where pixel tracking is not performed, the branch where pixel tracking is to be performed from the each branch where pixel tracking is not performed.

It is seen that, in embodiments of the present disclosure, for an intersection point of the target to be tracked where pixel tracking is not performed, a branch is selected from the each branch where pixel tracking is not performed according to the evaluated value of the each branch where pixel tracking is not performed, that is, a branch of the intersection point is selected accurately and reasonably.

In some embodiments of the present disclosure, the first processing module is configured to select the branch with a highest evaluated value in the each branch where pixel tracking is not performed.

It is seen that the branch selected is the branch with the highest evaluated value among the each branch where pixel tracking is not performed, and the evaluated value of the branch is acquired based on the true value of the target to be tracked. Therefore, the branch selected is more accurate.

In some embodiments of the present disclosure, the preset branch tracking stop condition includes at least one of the following:

a tracked next pixel being at a predetermined end of the target to be tracked;

a spatial entropy of the tracked next pixel being greater than a preset spatial entropy; or

N track route angles acquired consecutively all being greater than a set angle threshold, each track route angle acquired indicating an angle between two track routes acquired consecutively, each track route acquired indicating a line connecting two pixels tracked consecutively, the N being an integer greater than or equal to 2.

The end of the target to be tracked is pre-marked. When the tracked next pixel is at the predetermined end of the target to be tracked, it means that pixel tracking no longer has to be performed on the corresponding branch, in which case pixel tracking over the corresponding branch is stopped, improving accuracy in pixel tracking; the spatial entropy of a pixel indicates the instability of the pixel. The higher the spatial entropy of a pixel is, the higher the instability of the pixel, and it is not appropriate to continue pixel tracking on the current branch. At this time, jumping to the intersection point to continue pixel tracking improves accuracy in pixel tracking; when N track route angles acquired consecutively all are greater than a set angle threshold, it means the tracking routes acquired most recently have large oscillation amplitudes, and therefore, the accuracy of the tracked pixels is low. At this time, by stopping pixel tracking over the corresponding branch, accuracy in pixel tracking is improved.

In some embodiments of the present disclosure, the first processing module is configured to select a pixel with a highest evaluated value from the at least one candidate pixel, and determine the pixel with the highest evaluated value as the next pixel of the current pixel.

It is seen that the next pixel is the pixel with the highest evaluated value among the candidate pixels, and the evaluated value of a pixel is acquired based on the true value of the target to be tracked. Therefore, the next pixel acquired is more accurate.

In some embodiments of the present disclosure, the target to be tracked is a vascular tree.

It is seen that in the embodiment of the present disclosure, for a vascular tree, a next pixel is determined from a current pixel according to an evaluated value of a candidate pixel. That is, pixel tracking and extraction directed at the vascular tree is implemented accurately.

Embodiments of the present disclosure also provide a neural network training device. The device includes: a second acquiring module, a second processing module, an adjusting module, and a third processing module.

The second acquiring module is configured to acquire a sample image.

The second processing module is configured to input the sample image to an initial neural network, and perform following steps using the initial neural network: determining, based on a current pixel on a target to be tracked in the sample image, at least one candidate pixel on the target to be tracked; acquiring an evaluated value of the at least one candidate pixel based on the current pixel, the at least one candidate pixel, and a preset true value of the target to be tracked; acquiring a next pixel of the current pixel by performing tracking on the current pixel according to the evaluated value of the at least one candidate pixel.

The adjusting module is configured to adjust a network parameter value of the initial neural network according to each tracked pixel and the preset true value of the target to be tracked.

The third processing module is configured to repeat the steps of acquiring the sample image, processing the sample image using the initial neural network, and adjusting the network parameter value of the initial neural network, until each pixel acquired by the initial neural network with the adjusted network parameter value meets a preset precision requirement, acquiring a trained neural network.

Embodiments of the present disclosure also provide an electronic equipment, including a processor and a memory configured to store a computer program capable of running the processor.

The processor is configured to implement, when running the computer program, any one image processing method or any one neural network training method as mentioned above.

Embodiments of the present disclosure also provide a computer-readable storage medium having stored thereon a computer program which, when executed by a processor, implements any one image processing method or any one neural network training method as mentioned above.

Embodiments of the present disclosure also provide a computer program including computer-readable code which, when running in an electronic equipment, allows a processor in the electronic equipment to implement any one image processing method or any one neural network training method as mentioned above.

In an image processing and neural network training method, an electronic equipment, and a storage medium proposed in embodiments of the present disclosure, an image to be processed is acquired; at least one candidate pixel on the vascular tree is determined based on a current pixel on a vascular tree in the image to be processed; an evaluated value of the at least one candidate pixel is acquired based on the current pixel, the at least one candidate pixel, and a preset true value of the vascular tree; and a next pixel of the current pixel is acquired by performing tracking on the current pixel according to the evaluated value of the at least one candidate pixel. In this way, in embodiments of the present disclosure, for a target to be tracked, the next pixel is determined from the current pixel according to the evaluated value of a candidate pixel, that is, pixels of the target to be tracked is accurately tracked and extracted.

It should be understood that the general description above and the elaboration below are illustrative and explanatory only, and do not limit the present disclosure.

### BRIEF DESCRIPTION OF THE DRAWINGS

Drawings here are incorporated in and constitute part of the specification, illustrate embodiments in accordance with the present disclosure, and together with the specification, serve to explain the technical solution of embodiments of the present disclosure.

FIG. 1A is a flowchart of an image processing method according to an embodiment of the present disclosure.

FIG. 1B is a diagram of an application scene according to an embodiment of the present disclosure.

FIG. 2 is a flowchart of a neural network training method according to an embodiment of the present disclosure.

FIG. 3 is a diagram of a structure of an image processing device according to an embodiment of the present disclosure.

FIG. 4 is a diagram of a structure of a neural network training device according to an embodiment of the present disclosure.

FIG. 5 is a diagram of a structure of an electronic equipment according to an embodiment of the present disclosure.

### DETAILED DESCRIPTION

The present disclosure is further elaborated below with reference to the drawings and embodiments. It should be understood that an embodiment provided herein is intended to explain the present disclosure instead of limiting the present disclosure. In addition, embodiments provided below are part of the embodiments for implementing the present disclosure, rather than providing all the embodiments for implementing the present disclosure. Technical solutions recorded in embodiments of the present disclosure are implemented by being combined in any manner as long as no conflict results from the combination.

It is noted that in embodiments of the present disclosure, a term such as “including/comprising”, “containing”, or any other variant thereof is intended to cover a non-exclusive inclusion, such that a method or a device including a series of elements not only includes the elements explicitly listed, but also includes other element(s) not explicitly listed, or element(s) inherent to implementing the method or the device. Given no more limitation, an element defined by a phrase “including a . . . ” does not exclude existence of another relevant element (such as a step in a method or a unit in a device, where for example, the unit is part of a circuit, part of a processor, part of a program or software, etc.) in the method or the device that includes the element.

A term “and/or” herein merely describes an association between associated objects, indicating three possible relationships. For example, by A and/or B, it means that there are three cases, namely, existence of but A, existence of both A and B, or existence of but B. In addition, a term “at least one” herein means any one of multiple, or any combination of at least two of the multiple. For example, including at least one of A, B, and C means including any one or more elements selected from a set composed of A, B, and C.

For example, the image processing and neural network training methods provided by embodiments of the present disclosure include a series of steps. However, the image processing and neural network training methods provided by embodiments of the present disclosure are not limited to the recorded steps. Likewise, the image processing and neural network training devices provided by embodiments of the present disclosure includes a series of modules. However, devices provided by embodiments of the present disclosure are not limited to include the explicitly recorded modules, and also include a module required to acquire relevant information or perform processing based on information.

Embodiments of the present disclosure are applied to a computer system composed of a terminal and a server, and is operated with many other general-purpose or special-purpose computing system environments or configurations. Here, a terminal is a thin client, a thick client, handheld or laptop equipment, a microprocessor-based system, a set-top box, a programmable consumer electronic product, a network personal computer, a small computer system, etc. A server is a server computer system, a small computer system, a large computer system and distributed cloud computing technology environment including any of the above systems, etc.

An electronic equipment such as a terminal, a server, etc., is described in the general context of computer system executable instructions (such as a program module) executed by a computer system. Generally, program modules include a routine, a program, an object program, a component, a logic, a data structure, etc., which perform a specific task or implement a specific abstract data type. A computer system/server is implemented in a distributed cloud computing environment. In a distributed cloud computing environment, a task is executed by remote processing equipment linked through a communication network. In a distributed cloud computing environment, a program module is located on a storage medium of a local or remote computing system including storage equipment.

In related art, with the deepening and promotion of deep learning and reinforcement learning research, a Deep Reinforcement Learning (DRL) method produced by combining the two has achieved important results in fields such as artificial intelligence, robotics, etc., in recent years; illustratively, the DRL method is used to extract the centerline of a blood vessel. Specifically, the task of extracting the centerline of a blood vessel is constructed as a sequential decision-making model so as to perform training and learning using a DRL model. However, the method for extracting the centerline of a blood vessel is limited to a simple structure model for a single blood vessel, and cannot handle a complicated tree-like structure such as a cardiac coronary artery, a cranial blood vessel, etc.

In view of the above technical problem, in some embodiments of the present disclosure, an image processing method is proposed.

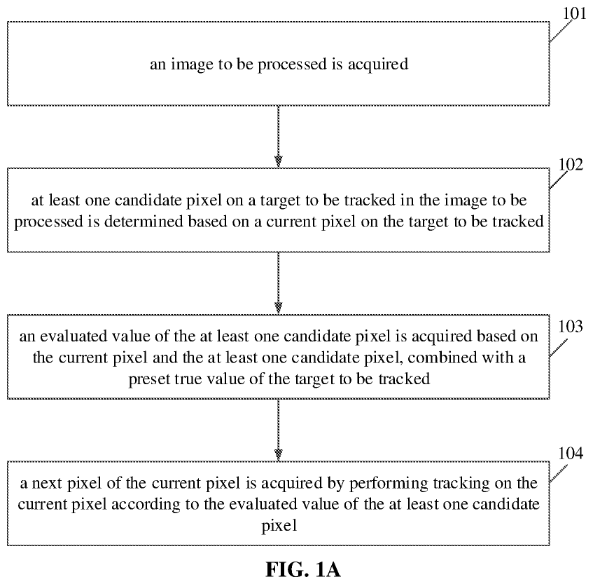

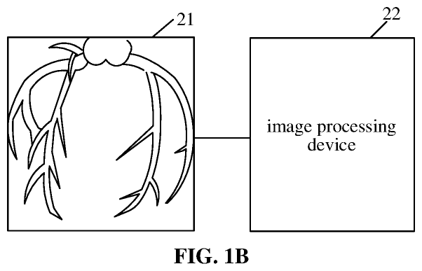

FIG. 1A is a flowchart of an image processing method according to an embodiment of the present disclosure. As shown in FIG. 1A, the flow includes steps as follows.

In Step 101, an image to be processed is acquired.

In embodiments of the present disclosure, an image to be processed is an image including a target to be tracked. A target to be tracked includes multiple branches. In some embodiments of the present disclosure, the target to be tracked is a vascular tree. A vascular tree represents a blood vessel with a tree-like structure. A tree-like blood vessel includes at least one bifurcation point; in some embodiments of the present disclosure, a tree-like blood vessel is a cardiac coronary artery, a cranial blood vessel, etc. An image to be processed is a three-dimensional medical image or another image containing a tree-like blood vessel. In some embodiments of the present disclosure, a three-dimensional image including a cardiac coronary artery is acquired based on cardiac coronary angiography.

In Step 102, at least one candidate pixel on a target to be tracked in the image to be processed is determined based on a current pixel on the target to be tracked.

Here, the current pixel on the target to be tracked is any pixel of the target to be tracked. In some embodiments of the present disclosure, when the target to be tracked is a vascular tree, the current pixel on the vascular tree represents any point of the vascular tree. In some embodiments of the present disclosure, the current pixel on the vascular tree is a pixel on the centerline of the vascular tree or another pixel on the vascular tree, and is not limited by embodiments of the present disclosure.

In embodiments of the present disclosure, at least one candidate pixel on the target to be tracked is a pixel adjacent to the current pixel. Therefore, after the current pixel on the target to be tracked in the image to be processed is determined, at least one candidate pixel on the target to be tracked is determined according to a pixel location relation.

In some embodiments of the present disclosure, the trend of the line connecting pixels local to the current pixel is determined according to pre-acquired structural information of the target to be tracked. Then, at least one candidate pixel is computed combining specific shape and size information of the target to be tracked.

In Step 103, an evaluated value of the at least one candidate pixel is acquired based on the current pixel, the at least one candidate pixel, and a preset true value of the target to be tracked.

Here, the preset true value of the target to be tracked represents a pre-marked pixel connection on the target to be tracked. The pixel connection represents path structure information of the target to be tracked. In a practical application, the pixel connection representing the path of the target to be tracked is manually marked for the target to be tracked; in some embodiments of the present disclosure, when the target to be tracked is a vascular tree, the centerline of the vascular tree is marked. The marked centerline of the vascular tree is taken as the true value of the vascular tree. It is noted that the above is only an illustrative description of the true value of the target to be tracked, which is not limited by embodiments of the present disclosure.

In embodiments of the present disclosure, the evaluated value of a candidate pixel indicates the suitability of the candidate pixel as the next pixel of the current pixel. In a practical implementation, the suitability of each candidate pixel as the next pixel is judged based on the preset true value of the target to be tracked. The higher the suitability of a candidate pixel as the next pixel, the higher the evaluated value of the candidate pixel. In some embodiments of the present disclosure, the matching degree that the line from the current pixel to the next pixel matches the preset true value of the target to be tracked is determined when the candidate pixel is taken as the next pixel. The higher the matching degree is, the higher the evaluated value of the candidate pixel.

In Step 104, a next pixel of the current pixel is acquired by performing tracking on the current pixel according to the evaluated value of the at least one candidate pixel.

Illustratively, the step is implemented by selecting, from at least one candidate pixel, the pixel with the highest evaluated value, and determining the selected pixel with the highest evaluated value as the next pixel.

It is seen that the next pixel is the pixel with the highest evaluated value among the candidate pixels, and the evaluated value of a pixel is acquired based on the true value of the target to be tracked. Therefore, the next pixel acquired is more accurate.

In a practical application, the current pixel is constantly changing. In some embodiments of the present disclosure, pixel tracking starts from a starting point of the target to be tracked; that is, the starting point of the target to be tracked is taken as the current pixel, and the next pixel is acquired through pixel tracking; then the tracked pixel is used as the current pixel to continue the pixel tracking; in this way, by repeating steps 102 to 104, a line connecting pixels of the target to be tracked is extracted.

In embodiments of the present disclosure, the starting point of the target to be tracked is predetermined. The starting point of the target to be tracked is a pixel at an entrance of the target to be tracked or another pixel of the target to be tracked; in some embodiments of the present disclosure, when the target to be tracked is a vascular tree, the starting point of the vascular tree is another pixel of the pixel at the entrance of the vascular tree. In a specific example, when the vascular tree is a cardiac coronary artery, the starting point of the vascular tree is a pixel at the entrance of the cardiac coronary artery.

In some embodiments of the present disclosure, when the target to be tracked is a vascular tree, and the starting point of the vascular tree is the center point of the entrance of the vascular tree, the centerline of the vascular tree is extracted through the pixel tracking process described above.

In a practical application, the starting point of the target to be tracked is determined according to the location information of the starting point of the target to be tracked input by a user. Alternatively, the location of the starting point of the target to be tracked is acquired by processing the image to be processed using a trained neural network for determining the starting point of the target to be tracked. In embodiments of the present disclosure, the network structure of the neural network for determining the starting point of the target to be tracked is not limited.

In a practical application, steps 101 to 104 are implemented based on the processor of the image processing device. The image processing device described above is User Equipment (UE), mobile equipment, a user terminal, a terminal, a cellular phone, a cordless phone, a Personal Digital Assistant (PDA), handheld equipment, computing equipment, onboard equipment, wearable equipment, etc. The above-mentioned processor is at least one of an Application Specific Integrated Circuit (ASIC), a Digital Signal Processor (DSP), a Digital Signal Processing Device (DSPD), a Programmable Logic Device PLD), a Field Programmable Gate Array (FPGA), a Central Processing Unit (CPU), a controller, a microcontroller, and a microprocessor. It is understandable that, for different electronic equipment, the electronic devices used to implement the above-mentioned processor functions are also others, which are not specifically limited in embodiments of the present disclosure.

It is seen that in embodiments of the present disclosure, for the target to be tracked, the next pixel is determined from the current pixel according to the evaluated value of a candidate pixel, that is, pixels of the target to be tracked is accurately tracked and extracted.

In some embodiments of the present disclosure, before determining, based on the current pixel on the target to be tracked in the image to be processed, the at least one candidate pixel on the target to be tracked, it is determined whether the current pixel is located at an intersection point of multiple branches on the target to be tracked; when the current pixel is located at the intersection point, a branch of the multiple branches is selected, and the candidate pixel is selected from pixels on the branch selected. That is, pixels of the branch selected are tracked. In some embodiments of the present disclosure, after selecting one branch of the multiple branches, step 102 to step 104 are executed for the branch selected, implementing pixel tracking on the branch selected. If the current pixel is not located at any intersection point of multiple branches on the target to be tracked, step 102 to step 104 are directly executed to determine the next pixel of the current pixel as the current pixel.

In some embodiments of the present disclosure, it is determined whether the current pixel is located at an intersection point of multiple branches on the target to be tracked based on a two-classification neural network. In the embodiments of the present disclosure, the network structure of the two-classification neural network is not limited, as long as the two-classification neural network determines whether the current pixel is located at an intersection point of multiple branches on the target to be tracked; for example, the network structure of the two-classification neural network is that of Convolutional Neural Networks (CNN), etc.

It is seen that by determining whether the current pixel is located at an intersection point of multiple branches on the target to be tracked, pixel tracking is implemented for multiple branches, that is, when the target to be tracked has branches, embodiments of the present disclosure track pixels of the branches of the target to be tracked.

Understandably, initially, no pixel tracking is performed on each branch corresponding to each intersection point. Therefore, any one branch of the intersection point is selected from the branches.

For the implementation of selecting one branch of multiple branches, illustratively, the evaluated value of each branch of the multiple branches is acquired based on the current pixel and the pixels of the multiple branches, combined with the preset true value of the target to be tracked. A branch is selected from the multiple branches according to the evaluated value of each branch in the multiple branches.

In a practical implementation, a candidate next pixel is determined respectively in the multiple branches. Then, the evaluated value of the next pixel is used as the evaluated value of the corresponding branch.

It is seen that, in embodiments of the present disclosure, for an intersection point of the target to be tracked, one branch is selected from the multiple branches according to evaluated values of the multiple branches, that is, a branch of the intersection point is selected accurately and reasonably.

For the implementation of selecting one branch from the multiple branches according to the evaluated value of each branch in the multiple branches, for example, among the multiple branches, a branch with the highest evaluated value is selected.

It is seen that the branch selected is the branch with the highest evaluated value, and the evaluated value of the branch is acquired based on the true value of the target to be tracked. Therefore, the branch selected is more accurate.

In some embodiments of the present disclosure, in response to performing tracking on the pixels of the branch selected, and determining that a preset branch tracking stop condition is met, for an intersection point with uncompleted pixel tracking that has a branch where pixel tracking is not performed, a branch where pixel tracking is to be performed is reselected, and pixel tracking is performed on the branch where pixel tracking is to be performed; and in response to nonexistence of the intersection point with uncompleted pixel tracking, it is determined that pixel tracking has been completed for each branch of each intersection point.

In a practical implementation, when it is determined that the current pixel is located at an intersection point of the branches on the target to be tracked, the intersection point is added to a jump list, to implement pixel jump of the pixel tracking process of the target to be tracked.

In some embodiments of the present disclosure, when tracking is performed on the pixels of the branch selected, and it is determined that a preset branch tracking stop condition is met, an intersection point in the jump list is selected, and then it is determined whether there is a branch corresponding to the selected intersection point where pixel tracking is not performed. If there is, a branch where pixel tracking is not performed is reselected for the selected intersection point, and pixel tracking is performed on the branch selected. If there is not, the intersection point is deleted from the jump list.

When there is no intersection point in the jump list, it means that there is no intersection point with uncompleted pixel tracking, that is, pixel tracking has been completed for each branch of each intersection point.

It is seen that by performing pixel tracking on each branch of each intersection point, the task of pixel tracking over the entire target to be tracked is implemented.

For the implementation of reselecting a branch where pixel tracking is to be performed, for example, based on the intersection point with uncompleted pixel tracking, pixels of each branch of the intersection point with uncompleted pixel tracking where pixel tracking is not performed, and the preset true value of the target to be tracked, an evaluated value of the each branch where pixel tracking is not performed, is acquired; and the branch where pixel tracking is to be performed is selected from the each branch where pixel tracking is not performed according to the evaluated value of the each branch where pixel tracking is not performed.

In a practical implementation, a candidate next pixel is determined respectively in each branch corresponding to the intersection point where pixel tracking is not performed. Then, the evaluated value of the next pixel is used as the evaluated value of the corresponding branch.

It is seen that, in embodiments of the present disclosure, for an intersection point of the target to be tracked where pixel tracking is not performed, a branch is selected from the each branch where pixel tracking is not performed according to the evaluated value of the each branch where pixel tracking is not performed, that is, a branch of the intersection point is selected accurately and reasonably.

For the implementation of selecting, according to the evaluated value of the each branch where pixel tracking is not performed, the branch where pixel tracking is to be performed from the each branch where pixel tracking is not performed, illustratively, the branch with a highest evaluated value in the each branch where pixel tracking is not performed is selected.

It is seen that the branch selected is the branch with the highest evaluated value among the each branch where pixel tracking is not performed, and the evaluated value of the branch is acquired based on the true value of the target to be tracked. Therefore, the branch selected is more accurate.

In some embodiments of the present disclosure, the preset branch tracking stop condition includes at least one of the following:

a tracked next pixel being at a predetermined end of the target to be tracked;

a spatial entropy of the tracked next pixel being greater than a preset spatial entropy; or

N track route angles acquired consecutively all being greater than a set angle threshold, each track route angle acquired indicating an angle between two track routes acquired consecutively, each track route acquired indicating a line connecting two pixels tracked consecutively, the N being an integer greater than or equal to 2.

Here, the N is a hyperparameter of a first neural network; the set angle threshold is preset according to a practical application requirement. For example, the set angle threshold is greater than 10 degrees. The end of the target to be tracked is pre-marked. When the tracked next pixel is at the predetermined end of the target to be tracked, it means that pixel tracking no longer has to be performed on the corresponding branch, in which case pixel tracking over the corresponding branch is stopped, improving accuracy in pixel tracking; the spatial entropy of a pixel indicates the instability of the pixel. The higher the spatial entropy of a pixel is, the higher the instability of the pixel, and it is not appropriate to continue pixel tracking on the current branch. At this time, jumping to the intersection point to continue pixel tracking improves accuracy in pixel tracking; when N track route angles acquired consecutively all are greater than a set angle threshold, it means the tracking routes acquired most recently have large oscillation amplitudes, and therefore, the accuracy of the tracked pixels is low. At this time, by stopping pixel tracking over the corresponding branch, accuracy in pixel tracking is improved.

In embodiments of the present disclosure, the trunk and branches of the target to be tracked are tracked. The trunk of the target to be tracked represents the route from the starting point of the target to be tracked to the first intersection point tracked. In the case of pixel tracking on the trunk or each branch of the target to be tracked, a DRL method is also used for pixel tracking.

In some embodiments of the present disclosure, a neural network with a Deep-Q-Network (DQN) framework is used to perform pixel tracking on the trunk or each branch of the target to be tracked; for example, an algorithm used in the DQN framework includes at least one of the following: Double-DQN, Dueling-DQN, prioritized memory replay, noisy layer; After determining the next pixel, a network parameter of the neural network with the DQN framework is updated according to the evaluated value of the next pixel.

In embodiments of the present disclosure, the network structure of the neural network with the DQN framework is not limited. For example, the neural network with the DQN framework includes two fully connected layers and three convolutional layers for feature downsampling.

In some embodiments of the present disclosure, the neural network with a DQN framework, the two-classification neural network, or the neural network for determining the starting point of the target to be tracked adopts a shallow neural network or a deep neural network. When the neural network with a DQN framework, the two-classification neural network, or the neural network for determining the starting point of the target to be tracked adopts a shallow neural network, the speed and efficiency of data processing by the neural network is improved.

To sum up, it is seen that in embodiments of the present disclosure, only the starting point of the target to be tracked needs to be determined, and then the above-mentioned image processing method is used to complete the task of pixel tracking over the target to be tracked. Moreover, when the starting point of the target to be tracked is determined using the neural network for determining the starting point of the target to be tracked, embodiments of the present disclosure automatically complete the task of pixel tracking over the entire target to be tracked for the acquired image to be processed.

In some embodiments of the present disclosure, after an image to be processed containing a cardiac coronary artery is acquired, according to the image processing method described above, it only takes 5 seconds to directly extract the centerline of a single cardiac coronary artery from the image to be processed. Uses of the centerline of a single cardiac coronary artery include but are not limited to: vessel naming, structure display, etc.

FIG. 1B is a diagram of an application scene according to an embodiment of the present disclosure. As shown in FIG. 1B, the blood vessel map 21 of a cardiac coronary artery is the image to be processed. Here, the blood vessel map 21 of the cardiac coronary artery is input to the image processing device 22. In the image processing device 22, through the image processing method described in the foregoing embodiments, the tracking and extraction of the pixels of the blood vessel map of the cardiac coronary artery are achieved. It is noted that the scene shown in FIG. 1B is only an illustrative scene of embodiments of the present disclosure, and the present disclosure does not limit specific application scenes.

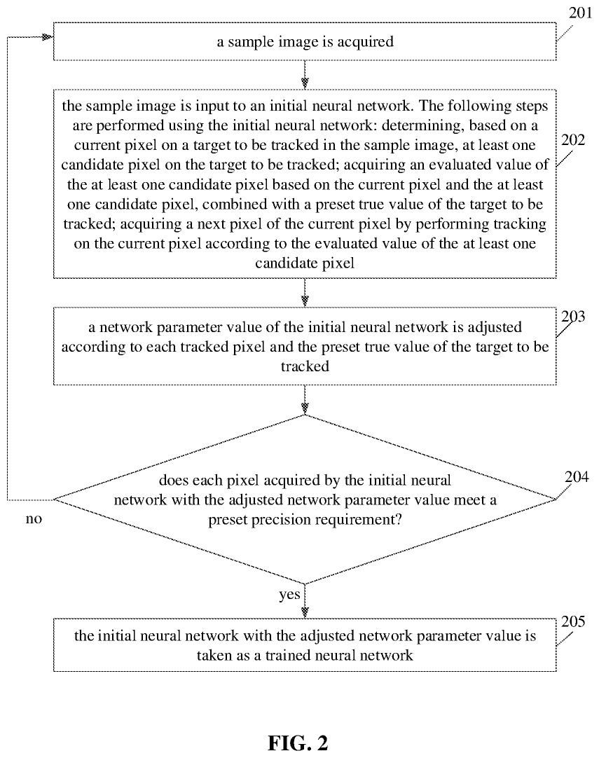

On the basis of the content, embodiments of the present disclosure also propose a neural network training method. FIG. 2 is a flowchart of a neural network training method according to an embodiment of the present disclosure. As shown in FIG. 2, the flow includes steps as follows.

In Step 201, a sample image is acquired.

In embodiments of the present disclosure, a sample image is an image including a target to be tracked.

In Step 202, the sample image is input to an initial neural network. The following steps are performed using the initial neural network: determining, based on a current pixel on a target to be tracked in the sample image, at least one candidate pixel on the target to be tracked; acquiring an evaluated value of the at least one candidate pixel based on the current pixel, the at least one candidate pixel, and a preset true value of the target to be tracked; acquiring a next pixel of the current pixel by performing tracking on the current pixel according to the evaluated value of the at least one candidate pixel.

In embodiments of the present disclosure, the implementation of the steps performed by the initial neural network has been described in the foregoing recorded content, and will not be repeated here.

In Step 203, a network parameter value of the initial neural network is adjusted according to each tracked pixel and the preset true value of the target to be tracked.

For the implementation of this step, for example, the loss of the initial neural network is acquired according to the centerline of each tracked pixel and the preset true value of the target to be tracked. A network parameter value of the initial neural network is adjusted according to the loss of the initial neural network. In some embodiments of the present disclosure, a network parameter value of the initial neural network is adjusted with the goal to reduce the loss of the initial neural network.

In a practical application, the true value of the target to be tracked is marked on a marking platform, for neural network training.

In Step 204, it is determined whether each pixel acquired by the initial neural network with the adjusted network parameter value meets a preset precision requirement. If it does not meet the preset precision requirement, steps 201 to 204 are again executed. If it meets the preset precision requirement, step 205 is executed.

In embodiments of the present disclosure, the preset precision requirement is determined according to the loss of the initial neural network. For example, the preset precision requirement is: the loss of the initial neural network being less than a set loss. In a practical application, the set loss is preset according to a practical application requirement.

In Step 205, the initial neural network with the adjusted network parameter value is taken as a trained neural network.

In the embodiments of the present disclosure, an image to be processed is processed directly using the trained neural network. That is, each pixel of the target to be tracked in the image to be processed is tracked. That is, a neural network, acquired through end-to-end training, for performing pixel tracking on a target to be tracked, is highly portable.

In a practical application, steps 201 to 205 are implemented using a processor in an electronic equipment. The processor is at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a controller, a microcontroller, and a microprocessor.

It is seen that in the embodiment of the present disclosure, when training a neural network, for a target to be tracked, a next pixel is determined from a current pixel according to an evaluated value of a candidate pixel. That is, pixel tracking and extraction directed at the target to be tracked are implemented accurately, so that the trained neural network accurately implements pixel tracking and extraction over the target to be tracked.

In some embodiments of the present disclosure, the initial neural network is also used to perform the following steps. Before determining, based on the current pixel on the target to be tracked in the sample image, the at least one candidate pixel on the target to be tracked, it is determined whether the current pixel is located at an intersection point of multiple branches on the target to be tracked; when the current pixel is located at the intersection point, a branch of the multiple branches is selected, and the candidate pixel is selected from pixels on the branch selected. That is, pixels of the branch selected are tracked. Specifically, after selecting one branch of the multiple branches, step 102 to step 104 are executed for the branch selected, implementing pixel tracking on the branch selected. If the current pixel is not located at any intersection point of multiple branches on the target to be tracked, step 102 to step 104 are directly executed to determine the next pixel of the current pixel as the current pixel.

In some embodiments of the present disclosure, the initial neural network is also used to perform the following steps. In response to performing tracking on the pixels of the branch selected, and determining that a preset branch tracking stop condition is met, for an intersection point with uncompleted pixel tracking that has a branch where pixel tracking is not performed, a branch where pixel tracking is to be performed is reselected, and pixel tracking is performed on the branch where pixel tracking is to be performed; and in response to nonexistence of the intersection point with uncompleted pixel tracking, it is determined that pixel tracking has been completed for each branch of each intersection point.

A person having ordinary skill in the art understands that in a method of a specific implementation, the order in which the steps are put is not necessarily a strict order in which the steps are implemented, and does not form any limitation to the implementation process. A specific order in which the steps are implemented should be determined based on a function and a possible intrinsic logic thereof.

On the basis of the image processing method proposed in the foregoing embodiments, embodiments of the present disclosure also propose an image processing device.

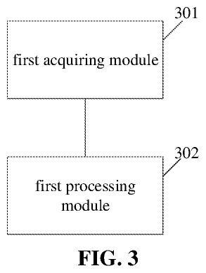

FIG. 3 is a diagram of a structure of an image processing device according to an embodiment of the present disclosure. As shown in FIG. 3, the device includes a first acquiring module 301 and a first processing module 302.

The first acquiring module 301 is configured to acquire an image to be processed.

The first processing module 302 is configured to: determine, based on a current pixel on a target to be tracked in the image to be processed, at least one candidate pixel on the target to be tracked; acquire an evaluated value of the at least one candidate pixel based on the current pixel, the at least one candidate pixel, and a preset true value of the target to be tracked; and acquire a next pixel of the current pixel by performing tracking on the current pixel according to the evaluated value of the at least one candidate pixel.

In some embodiments of the present disclosure, the first processing module 302 is further configured to: before determining, based on the current pixel on the target to be tracked in the image to be processed, the at least one candidate pixel on the target to be tracked, determine whether the current pixel is located at an intersection point of multiple branches on the target to be tracked; in response to the current pixel being located at the intersection point, select a branch of the multiple branches, and select the candidate pixel from pixels on the branch selected.

In some embodiments of the present disclosure, the first processing module 302 is configured to: acquire an evaluated value of each branch of the multiple branches based on the current pixel, pixels of the multiple branches, and the preset true value of the target to be tracked; and select the branch from the multiple branches according to the evaluated value of the each branch of the multiple branches.

In some embodiments of the present disclosure, the first processing module 302 is configured to select the branch with a highest evaluated value in the multiple branches.

In some embodiments of the present disclosure, the first processing module 302 is further configured to:

in response to performing tracking on the pixels of the branch selected, and determining that a preset branch tracking stop condition is met, for an intersection point with uncompleted pixel tracking that has a branch where pixel tracking is not performed, reselect a branch where pixel tracking is to be performed, and perform pixel tracking on the branch where pixel tracking is to be performed; and

in response to nonexistence of the intersection point with uncompleted pixel tracking, determine that pixel tracking has been completed for each branch of each intersection point.

In some embodiments of the present disclosure, the first processing module 302 is configured to: based on the intersection point with uncompleted pixel tracking, pixels of each branch of the intersection point with uncompleted pixel tracking where pixel tracking is not performed, and the preset true value of the target to be tracked, acquire an evaluated value of the each branch where pixel tracking is not performed; and select, according to the evaluated value of the each branch where pixel tracking is not performed, the branch where pixel tracking is to be performed from the each branch where pixel tracking is not performed.

In some embodiments of the present disclosure, the first processing module 302 is configured to select the branch with a highest evaluated value in the each branch where pixel tracking is not performed.

In some embodiments of the present disclosure, the preset branch tracking stop condition includes at least one of the following:

a tracked next pixel being at a predetermined end of the target to be tracked;

a spatial entropy of the tracked next pixel being greater than a preset spatial entropy; or

N track route angles acquired consecutively all being greater than a set angle threshold, each track route angle acquired indicating an angle between two track routes acquired consecutively, each track route acquired indicating a line connecting two pixels tracked consecutively, the N being an integer greater than or equal to 2.

The end of the target to be tracked is pre-marked. When the tracked next pixel is at the predetermined end of the target to be tracked, it means that pixel tracking no longer has to be performed on the corresponding branch, in which case pixel tracking over the corresponding branch is stopped, improving accuracy in pixel tracking; the spatial entropy of a pixel indicates the instability of the pixel. The higher the spatial entropy of a pixel is, the higher the instability of the pixel, and it is not appropriate to continue pixel tracking on the current branch. At this time, jumping to the intersection point to continue pixel tracking improves accuracy in pixel tracking; when N track route angles acquired consecutively all are greater than a set angle threshold, it means the tracking routes acquired most recently have large oscillation amplitudes, and therefore, the accuracy of the tracked pixels is low. At this time, by stopping pixel tracking over the corresponding branch, accuracy in pixel tracking is improved.

In some embodiments of the present disclosure, the first processing module 302 is configured to select a pixel with a highest evaluated value from the at least one candidate pixel, and determine the pixel with the highest evaluated value as the next pixel of the current pixel.

In some embodiments of the present disclosure, the target to be tracked is a vascular tree.

Both the first acquiring module 301 and the first processing module 302 are implemented by a processor located in an electronic equipment. The processor is at least one of an ASIC, a DSP, a DSPD, a PLD, a FPGA, a CPU, a controller, a microcontroller, and a microprocessor.

On the basis of the neural network training method proposed in the foregoing embodiments, embodiments of the present disclosure also propose a neural network training device.

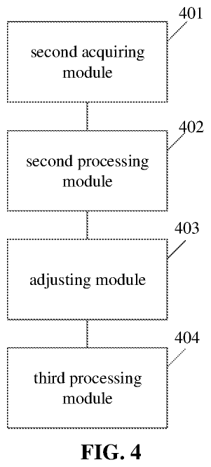

FIG. 4 is a diagram of a structure of a neural network training device according to an embodiment of the present disclosure. As shown in FIG. 4, the device includes a second acquiring module 401, a second processing module 402, an adjusting module 403, and a third processing module 404.

The second acquiring module 401 is configured to acquire a sample image.

The second processing module 402 is configured to input the sample image to an initial neural network, and perform following steps using the initial neural network: determining, based on a current pixel on a target to be tracked in the sample image, at least one candidate pixel on the target to be tracked; acquiring an evaluated value of the at least one candidate pixel based on the current pixel, the at least one candidate pixel, and a preset true value of the target to be tracked; acquiring a next pixel of the current pixel by performing tracking on the current pixel according to the evaluated value of the at least one candidate pixel.

The adjusting module 403 is configured to adjust a network parameter value of the initial neural network according to each tracked pixel and the preset true value of the target to be tracked.

The third processing module 404 is configured to repeat the steps of acquiring the sample image, processing the sample image using the initial neural network, and adjusting the network parameter value of the initial neural network, until each pixel acquired by the initial neural network with the adjusted network parameter value meets a preset precision requirement, acquiring a trained neural network.

The second acquiring module 401, the second processing module 402, the adjusting module 403, and the third processing module 404 are all be implemented by a processor located in an electronic equipment. The processor is at least one of an ASIC, a DSP, a DSPD, a PLD, a FPGA, a CPU, a controller, a microcontroller, and a microprocessor.

In addition, various functional modules in the embodiments are integrated in one processing part, or exist as separate physical parts respectively. Alternatively, two or more such parts are integrated in one part. The integrated part is implemented in form of hardware or software functional unit(s).

When implemented in form of a software functional module and sold or used as an independent product, an integrated unit herein is stored in a computer-readable storage medium. Based on such an understanding, the essential part of the technical solution of the embodiments or a part contributing to prior art or all or part of the technical solution appears in form of a software product, which software product is stored in storage media, and includes a number of instructions for allowing computer equipment (such as a personal computer, a server, network equipment, and/or the like) or a processor to execute all or part of the steps of the methods of the embodiments. The storage media include various media that can store program codes, such as a USB flash disk, a mobile hard disk, Read Only Memory (ROM), Random Access Memory (RAM), a magnetic disk, a CD, and/or the like.

Specifically, the computer program instructions corresponding to an image processing method or a neural network training method in the embodiments are stored on a storage medium such as a CD, a hard disk, a USB flash disk. When read by an electronic equipment or executed, computer program instructions in the storage medium corresponding to an image processing method or a neural network training method implement any one image processing method or any one neural network training method of the foregoing embodiments.

Based on the technical concept same as that of the foregoing embodiments, embodiments of the present disclosure also propose a computer program including a computer readable code which, when running in an electronic equipment, allows a processor in the electronic equipment to implement any one image processing method or any one neural network training method of the foregoing embodiments.

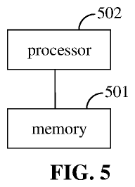

Based on the technical concept same as that of the foregoing embodiments, refer to FIG. 5, which shows an electronic equipment provided by embodiments of the present disclosure. The electronic equipment includes: a memory 501 and a processor 502.

The memory 501 is configured to store computer programs and data.

The processor 502 is configured to execute a computer program stored in the memory to implement any one image processing method or any one neural network training method of the foregoing embodiments.

In a practical application, the memory 501 is a volatile memory such as RAM; or non-volatile memory such as ROM, flash memory, a Hard Disk Drive (HDD), or a Solid-State Drive (SSD); or a combination of the foregoing types of memories, and provide instructions and data to the processor 502.

The processor 502 is at least one of an ASIC, a DSP, a DSPD, a PLD, a FPGA, a CPU, a controller, a microcontroller, and a microprocessor. It is understandable that, for different augmented reality cloud platforms, the electronic devices used to implement the above-mentioned processor functions are also others, which is not specifically limited in embodiments of the present disclosure.

In some embodiments, a function or a module of a device provided in embodiments of the present disclosure is configured to implement a method described in a method embodiment herein. Refer to description of a method embodiment herein for specific implementation of the device, which is not repeated here for brevity.

The above description of the various embodiments tends to emphasize differences in the various embodiments. Refer to one another for identical or similar parts among the embodiments, which are not repeated for conciseness.

Methods disclosed in method embodiments of the present disclosure are combined with each other as needed to acquire a new method embodiment, as long as no conflict results from the combination.

Features disclosed in product embodiments of the present disclosure are combined with each other as needed to acquire a new product embodiment, as long as no conflict results from the combination.

Features disclosed in method or equipment embodiments of the present disclosure are combined with each other as needed to acquire a new method or equipment embodiment, as long as no conflict results from the combination.

Through the description of the above embodiments, a person having ordinary skill in the art clearly understands that the methods of the above embodiments are implemented by hardware, or often better, by software plus a necessary general hardware platform. Based on this understanding, the essential part or the part contributing to prior art of a technical solution of the present disclosure is embodied in form of a software product. The computer software product is stored in a storage medium (such as ROM/RAM, a magnetic disk, and a CD) and includes a number of instructions that allow terminal (which is a mobile phone, a computer, a server, an air conditioner, or a network device, etc.) to execute a method described in the various embodiments of the present disclosure.

Embodiments of the present disclosure are described above with reference to the accompanying drawings. However, the present disclosure is not limited to the above-mentioned specific implementations. The above-mentioned specific implementations are only illustrative but not restrictive. Inspired by the present disclosure, a person having ordinary skill in the art further implements many forms without departing from the purpose of the present disclosure and the scope of the claims. These forms are all covered by protection of the present disclosure.

### INDUSTRIAL APPLICABILITY

Embodiment of the present disclosure proposes an image processing and neural network training method and device, an electronic equipment, and a computer-readable storage medium. The image processing method includes: acquiring an image to be processed; determining, based on a current pixel on a target to be tracked in the image to be processed, at least one candidate pixel on the target to be tracked; acquiring an evaluated value of the at least one candidate pixel based on the current pixel, the at least one candidate pixel, and a preset true value of the target to be tracked; and acquiring a next pixel of the current pixel by performing tracking on the current pixel according to the evaluated value of the at least one candidate pixel. In this way, in embodiments of the present disclosure, for a target to be tracked, the next pixel is determined from the current pixel according to the evaluated value of a candidate pixel, that is, pixels of the target to be tracked is accurately tracked and extracted.

1. An image processing method, comprising:
acquiring an image to be processed;
determining, based on a current pixel on a target to be tracked in the image to be processed, at least one candidate pixel on the target to be tracked;
acquiring an evaluated value of the at least one candidate pixel based on the current pixel, the at least one candidate pixel, and a preset true value of the target to be tracked; and
acquiring a next pixel of the current pixel by performing tracking on the current pixel according to the evaluated value of the at least one candidate pixel.

2. The image processing method of claim 1, comprising: before determining, based on the current pixel on the target to be tracked in the image to be processed, the at least one candidate pixel on the target to be tracked,
determining whether the current pixel is located at an intersection point of multiple branches on the target to be tracked; in response to the current pixel being located at the intersection point, selecting a branch of the multiple branches, and selecting the candidate pixel from pixels on the branch selected.

3. The image processing method of claim 2, wherein selecting the branch of the multiple branches comprises:
acquiring an evaluated value of each branch of the multiple branches based on the current pixel, pixels of the multiple branches, and the preset true value of the target to be tracked; and
selecting the branch from the multiple branches according to the evaluated value of the each branch of the multiple branches.

4. The image processing method of claim 3, wherein selecting the branch from the multiple branches according to the evaluated value of the each branch of the multiple branches comprises:
selecting the branch with a highest evaluated value in the multiple branches.

5. The image processing method of claim 2, further comprising:
in response to performing tracking on the pixels of the branch selected, and determining that a preset branch tracking stop condition is met, for an intersection point with uncompleted pixel tracking that has a branch where pixel tracking is not performed, reselecting a branch where pixel tracking is to be performed, and performing pixel tracking on the branch where pixel tracking is to be performed; and
in response to nonexistence of the intersection point with uncompleted pixel tracking, determining that pixel tracking has been completed for each branch of each intersection point.

6. The image processing method of claim 5, wherein reselecting the branch where pixel tracking is to be performed comprises:
based on the intersection point with uncompleted pixel tracking, pixels of each branch of the intersection point with uncompleted pixel tracking where pixel tracking is not performed, and the preset true value of the target to be tracked, acquiring an evaluated value of the each branch where pixel tracking is not performed; and
selecting, according to the evaluated value of the each branch where pixel tracking is not performed, the branch where pixel tracking is to be performed from the each branch where pixel tracking is not performed.

7. The image processing method of claim 6, wherein selecting, according to the evaluated value of the each branch where pixel tracking is not performed, the branch where pixel tracking is to be performed from the each branch where pixel tracking is not performed comprises:
selecting the branch with a highest evaluated value in the each branch where pixel tracking is not performed.

8. The image processing method of claim 5, wherein the preset branch tracking stop condition comprises at least one of the following:
a tracked next pixel being at a predetermined end of the target to be tracked;
a spatial entropy of the tracked next pixel being greater than a preset spatial entropy; or
N track route angles acquired consecutively all being greater than a set angle threshold, each track route angle acquired indicating an angle between two track routes acquired consecutively, each track route acquired indicating a line connecting two pixels tracked consecutively, the N being an integer greater than or equal to 2.

9. The image processing method of claim 1, wherein acquiring the next pixel of the current pixel by performing tracking on the current pixel according to the evaluated value of the at least one candidate pixel comprises:
selecting a pixel with a highest evaluated value from the at least one candidate pixel, and determining the pixel with the highest evaluated value as the next pixel of the current pixel.

10. The image processing method of claim 1, wherein the target to be tracked is a vascular tree.

11. A neural network training method, comprising:
acquiring a sample image;
inputting the sample image to an initial neural network, and performing the image processing method of claim 1 using the initial neural network, by taking the sample image as the image to be processed; and
adjusting a network parameter value of the initial neural network according to each tracked pixel and the preset true value of the target to be tracked, until each pixel acquired by the initial neural network with the adjusted network parameter value meets a preset precision requirement.

12. An electronic equipment, comprising a processor and a memory connected to the processor,
wherein the processor is configured to implement, by executing computer-executable instructions stored in the memory:
acquiring an image to be processed;
determining, based on a current pixel on a target to be tracked in the image to be processed, at least one candidate pixel on the target to be tracked;
acquiring an evaluated value of the at least one candidate pixel based on the current pixel, the at least one candidate pixel, and a preset true value of the target to be tracked; and
acquiring a next pixel of the current pixel by performing tracking on the current pixel according to the evaluated value of the at least one candidate pixel.

13. The electronic equipment of claim 12, wherein the processor is configured to implement: before determining, based on the current pixel on the target to be tracked in the image to be processed, the at least one candidate pixel on the target to be tracked,
determining whether the current pixel is located at an intersection point of multiple branches on the target to be tracked; in response to the current pixel being located at the intersection point, selecting a branch of the multiple branches, and selecting the candidate pixel from pixels on the branch selected.

14. The electronic equipment of claim 13, wherein the processor is configured to select the branch of the multiple branches, by:
acquiring an evaluated value of each branch of the multiple branches based on the current pixel, pixels of the multiple branches, and the preset true value of the target to be tracked; and
selecting the branch from the multiple branches according to the evaluated value of the each branch of the multiple branches.

15. The electronic equipment of claim 14, wherein the processor is configured to select the branch from the multiple branches according to the evaluated value of the each branch of the multiple branches, by:
selecting the branch with a highest evaluated value in the multiple branches.

16. The electronic equipment of claim 13, wherein the processor is further configured to implement:
in response to performing tracking on the pixels of the branch selected, and determining that a preset branch tracking stop condition is met, for an intersection point with uncompleted pixel tracking that has a branch where pixel tracking is not performed, reselecting a branch where pixel tracking is to be performed, and performing pixel tracking on the branch where pixel tracking is to be performed; and
in response to nonexistence of the intersection point with uncompleted pixel tracking, determining that pixel tracking has been completed for each branch of each intersection point.

17. The electronic equipment of claim 16, wherein the processor is configured to reselect the branch where pixel tracking is to be performed, by:
based on the intersection point with uncompleted pixel tracking, pixels of each branch of the intersection point with uncompleted pixel tracking where pixel tracking is not performed, and the preset true value of the target to be tracked, acquiring an evaluated value of the each branch where pixel tracking is not performed; and
selecting, according to the evaluated value of the each branch where pixel tracking is not performed, the branch where pixel tracking is to be performed from the each branch where pixel tracking is not performed.

18. The electronic equipment of claim 12, wherein the processor is configured to acquire the next pixel of the current pixel by performing tracking on the current pixel according to the evaluated value of the at least one candidate pixel, by:
selecting a pixel with a highest evaluated value from the at least one candidate pixel, and determining the pixel with the highest evaluated value as the next pixel of the current pixel.

19. The electronic equipment of claim 12, wherein the target to be tracked is a vascular tree.

20. A non-transitory computer-readable storage medium, having stored thereon computer-executable instructions which, when executed by a processor, implement:
acquiring an image to be processed;
determining, based on a current pixel on a target to be tracked in the image to be processed, at least one candidate pixel on the target to be tracked;
acquiring an evaluated value of the at least one candidate pixel based on the current pixel, the at least one candidate pixel, and a preset true value of the target to be tracked; and
acquiring a next pixel of the current pixel by performing tracking on the current pixel according to the evaluated value of the at least one candidate pixel.
